(19) United States
(12) Patent Application Publication
(10) Pub. No.: US 2001/0037281 A1
(43) Pub. Date: Nov. 1, 2001

(54) Request for quote (RFQ) system and method

(76) Inventors: Jason French, Chicago, IL (US); Kurt J. Laning, Barrington, IL (US); Warren T. Wamberg, Barrington, IL (US)

Correspondence Address: DICKSTEIN SHAPIRO MORIN & OSHINSKY LLP, Jon D. Grossman, 2101 L Street NW, Washington, DC, 20037-1526, US

(21) Appl. No.: 09/808,137

(22) Filed: Mar. 15, 2001

Related U.S. Application Data
(60) Provisional application No. 60/196,919, filed on Apr. 13, 2000.

(51) Int. Cl. G06F 17/60

(52) U.S. Cl. 705/37; 705/26

(57) ABSTRACT

A system and method for conducting an electronic auction has one or more carriers submitting one or more price quotes for goods or services in response to a request by a consumer who desires to purchase the goods or services.

### FIELD OF THE INVENTION

The present invention relates to an electronic system and method, and more particularly to a new system and method for an on-line auction in which certain selected carriers of goods and services can compete with one another to provide their best price quote or best rate-of-return quote in response to a request from a customer who is interested in purchasing the carriers' goods or services.

### BACKGROUND OF THE INVENTION

Dealers of goods and services are continually seeking markets for their products. Consumers who desire these products are always looking to be provided the best financial terms, i.e. the best “deal” on the product. Until recently, comparing prices and terms was almost always a tedious and arduous affair known as “comparison shopping.” Even traditional brokers, or middlemen, were of little help to the consumer. These agents, while often having ready access to a large number of dealers and suppliers of products, often did not have access to a reliable, easy system by which they could quickly obtain the most competitive prices for the consumer.

On-line shopping has revolutionized the way consumers and merchants do business with the advent of such services as priceline.com as described in U.S. Pat. No. 5,897,620. According to this method, the consumer names a price that he or she is willing to pay for a good or service. Interested merchants then notify the consumer that the product is available at the asking price, and a deal is consummated. If the price set by the consumer is not at or above a certain minimum, then the merchant does not provide the product. Unfortunately, the consumer does not know this when he places his bid. Therefore, there is always the risk that the consumer will bid higher than the price for which the product could still profitably be sold. The consumer thus may not obtain the product at the best possible price. The consumer's best interests are therefore not always protected by this method of shopping.

In addition, in the financial services sector there are commercial entities such as banks which often seek to purchase life insurance policies on their employees. Such policies are termed BOLI, or bank-owned life insurance. The bank sells a portion of its investments on the open market, and then purchases BOLI using the proceeds to fund the premiums which are then paid to a BOLI carrier. The BOLI carrier in turn then insures a group of the bank's employees under a specially designed BOLI plan. The bank owns the policies, the cash values and receives the death benefits. The BOLI policies also create additional income to the bank, as the funds (premiums) are deposited by the BOLI carrier in one or more revenue-generating media, and thereby earn the bank an annual rate of return on its funds. These yields may be tax-advantaged. This increases the bank's annual net income and earnings per share, and the bank can utilize this money to finance its employee benefit plan costs. According to federal regulations, a bank is permitted to purchase enough BOLI to cover the cost of its employee plan expenses. It is therefore in the bank's interest to obtain the highest possible yield, or highest rate of return, on its BOLI premiums, or at least a certain level of return which will allow it to cover its benefit plans' costs.

Thus, there is a need in the art for a better system and method by which a customer can obtain the best possible price on-line for a particular good or service. There is also a need for a system and method for a commercial customer, such as bank, to obtain the best rate of return on an insurance plan such as BOLI. The system and method should substantially eliminate haphazard guessing by the customer as to what is the best price or best rate of return, etc.

### SUMMARY OF THE INVENTION

The invention according to a first embodiment provides a method for a consumer to obtain a price quote for a product on-line. According to this method the consumer submits a request for a price quote on a certain product to an electronic staging area, wherein the quote desirably includes at least one product specification. The method further involves at least one carrier, in turn, submitting at least one quote to the consumer via the staging area in response to the request for a quote. Preferably, the request for quote is forwarded to at least two carriers who compete with one another during a specified auction period to provide the consumer with the best price quote for the product.

Also provided as part of the invention is a method by which a carrier, and preferably at least two carriers of a certain product can provide a price quote for the product in response to a request for a quote from a consumer. At least one carrier submits a first price quote to a staging area for review or screening. A second carrier can then submit a second price quote to a staging area. The consumer can then decide which of the price quotes is the most competitive.

In another embodiment of the invention, there is provided a method of brokering a transaction on-line. The method first comprises displaying in an electronic staging area at least one request for a price quote from a consumer for a product the consumer is interested in purchasing. Next, a quote is submitted from a carrier who supplies the particular product, and this quote is forwarded to the staging area for viewing by the consumer. Preferably, the request for a quote is forwarded to at least two carriers of the product who then compete with one another to provide the consumer with the best price quote via the electronic staging area.

In yet another embodiment of the invention, there is provided a system for conducting an on-line auction. The system includes a broker interface which monitors and controls an electronic staging area. The electronic staging area displays requests for price quotes from consumers who are interested in purchasing a product, and also displays the price quotes received from one or more carriers who sell the desired product.

Also provided as part of the invention is a method for a broker to conduct an on-line auction. The method entails electronically pre-registering at least one customer who is interested in obtaining a competitive price quote on a product, as well as pre-registering at least two carriers of the subject product. The method also involves establishing a time for the on-line auction. During the auction period, the broker will have the customer submit a request for a price quote on the product, and then will have at least one of the carriers submit a first price quote in response to the customer's request. The first price quote is then posted by the broker for viewing by the customer and/or by the carriers participating in the auction. Next, the broker will have a second carrier submit a second price quote in response to both the customer's request and the first price quote. This second price quote is then posted by the broker for viewing by at least one of the parties. The second price quote is desirably more competitive than was the first price quote.

Further provided as part of the invention is a method for competitively quoting a rate of return on funds deposited with a bank-owned life insurance (BOLI) policy plan. The method involves pre-registering at least one financial institution that is seeking to male a purchase of BOLI and that desires to receive a competitive quote on the rate of return from its premiums paid into BOLI. The method also involves pre-registering at least two carriers of BOLI. An auction time and period is also established. The financial institution is then invited to submit a request for a quote during the auction, wherein the financial institution forwards its quote during the auction period. A first carrier is invited to submit a rate of return in response to the request, wherein the carrier then forwards its quote where it is posted in an electronic staging area. A second carrier is invited to submit a rate of return in response to the request and to the quote submitted by the first carrier, wherein the second carrier forwards a second quote which is also posted in the electronic staging area. The second quote should be more competitive than the first quote.

The invention is also directed to an electronic system useful in conducting an on-line auction for rates-of-return on finds deposited in bank-owned life insurance (BOLI). The system includes a broker-controlled staging area for displaying requests by financial institutions for rates of return on BOLI funds, and for displaying responses received to the requests during an on-line auction. The staging area is in communication with a broker interface.

Additional advantages and features of the present invention will become more readily apparent from the following detailed description and drawings which illustrate various embodiments of the invention.

### BRIEF DESCRIPTION OF THE DRAWINGS

FIG. 1 depicts a block diagram of a request for quote (RFQ) system.

FIG. 2 is an exemplary flow chart depicting an RFQ process and auction using the system of FIG. 1.

FIG. 3 is a sample census data form for use as part of the method shown in FIG. 2 according to one embodiment of the invention.

FIG. 4 is a schematic representation of step 1113 shown in FIG. 2 according to one embodiment of the invention.

FIG. 5 is a first chart with real-time postings of rates of return on BOLI as part of the cycle of steps 1130 through 1160 shown in FIG. 2 according to one embodiment of the invention.

FIG. 6 is a second chart with real-time postings of rates of return on BOLI with various named carriers.

### DETAILED DESCRIPTION OF THE PREFERRED EMBODIMENTS

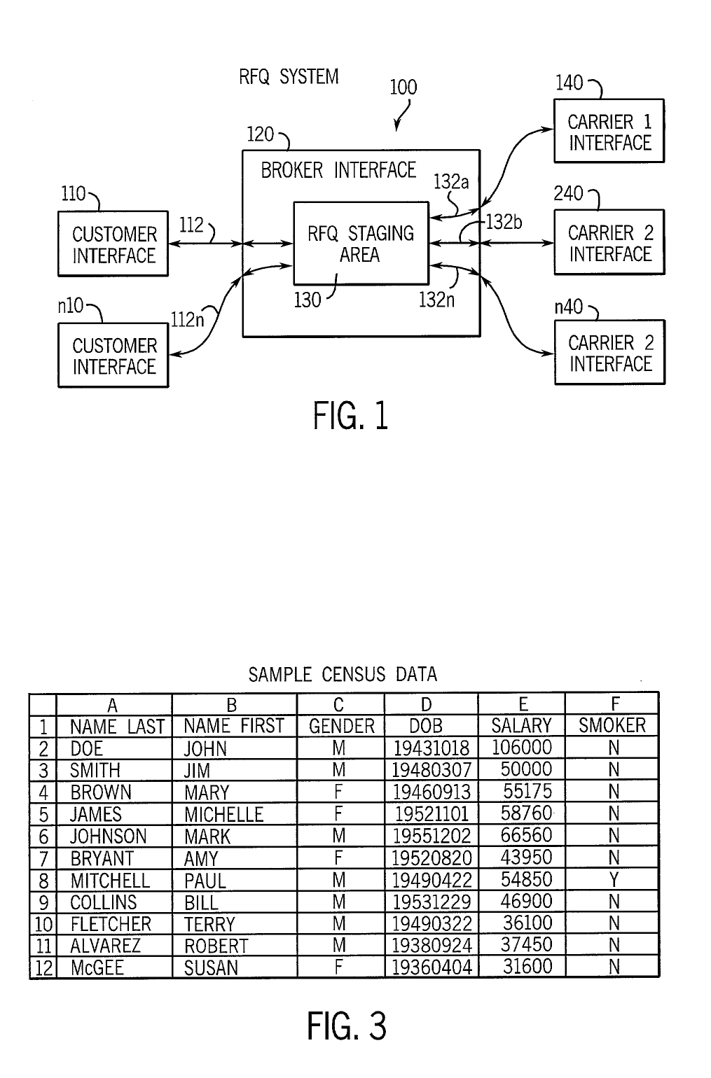

Referring now to the drawings, FIG. 1 illustrates a request for quote (RFQ) system 100. Shown in FIG. 1 as part of the system 100 is a customer interface 110, a broker interface 120 which contains an RFQ staging area 130, and carrier interfaces 140, 240, and n40, corresponding to the number of carriers who have access to the RFQ system.

As that term is used herein, “customer” may be used interchangeably with “consumer” and shall refer to any individual, group, business, entity or entities which is interested in purchasing at least one product or service at the most competitive price. The most competitive price can refer to the best possible price or to the lowest possible price, but can also mean the best rate of return, for example, on funds which the customer seeks to invest. The most competitive price can also be subjective, meaning whatever the customer thinks it is according to his/her best judgment. In a preferred embodiment of the invention, the customer would represent a bank or other financial institution, either individually or collectively with other banks (e.g. as a “pool”), that was interested in obtaining the most competitive rate of return on a bank-owned life insurance (BOLI) plan.

The customer interface 110 shall include all means which allows the customer to utilize the RFQ system and method. Preferably, the customer interface 110 shall be an electronic medium, and more preferably shall include a website on the internet accessible by a computer. For purposes of clarity, FIG. 1 shows one customer interface 110, but it is to be understood that the system 100 would preferably be configured to have as many separate customer interfaces n10 as there were different customers who desired to participate in the RFQ process and submit requests for quotes on-line.

In addition, “broker” shall refer to any entity which can control and direct the RFQ system and method, including the auction as hereinafter described between the customer and one or more carrier(s). Broker shall also mean a consultant or middleman in the traditional sense. The broker interface 120 shall include any means by which the broker can access, control and direct the RFQ system and method, including the RFQ staging area 130, and thus encompasses the means by which the broker can coordinate the RFQ activities between the customer and the carrier(s). Preferably, this shall include an electronic medium such as a computer, along with the available databases, hardware and software that will program and maintain the RFQ system and method. The RFQ staging area 130 shall refer to any venue at which the activities associated with the RFQ system and method may be staged. Preferably, the staging area is an electronic venue, e.g. internet website, which is accessible to the customer and the carrier(s), as well as to the broker.

The term “carrier” as used herein shall refer to any dealer or supplier of any goods or services, including suppliers of financial services, e.g. insurance services and investment products. In a preferred embodiment of the invention, the carrier is an insurance carrier that specializes in BOLI. The carrier interface 140 shall include all means by which the carrier(s) can utilize the RFQ system and method. Like the customer interface 110, this is preferably an electronic medium such as a website on the internet accessible by a computer or similar device.

Line 112 in FIG. 1 represents a means of communication, preferably an electronic link or modem, between the customer interface 110 and the broker interface 120, and between the customer interface 110 and the RFQ staging area 130. Line 112 could therefore represent more than one link. Lines 132a, 132b and 132n each represent at least means of communication, e.g. electronic link or modem, between carrier interfaces 140, 240, and n40, respectively, and the broker interface 120 and the RFQ staging area 130. Optionally, the system 100 shown in FIG. 1 could be configured so that communications means, e.g. modem links or the link, could exist between the customer interface 110 and the carrier interfaces 140, 240, n40 as well, which in certain embodiments could obviate the need for a broker, broker interface 120 and an electronic staging area 130. In these embodiments, the respective customer and carrier interfaces would function as electronic staging areas. In addition, the entire system 100 is also shown without the attendant available hardware, e.g. computer screens, and software programs which would otherwise be inherently configured therein, and which is otherwise available to the skilled artisan.

Prior to initiating an actual RFQ process, a customer would first indicate his desire to be a participant in the RFQ system and process by pre-registration. This would be done by first accessing the system 100. Preferably, this would involve directly logging on to the appropriate web site(s) which may be designated “www.(name(s) of website).com”, via a computer at the customer interface 110. Access could also be gained via electronic links, e.g. hyperlinks, from other websites. The first step in pre-registration would preferably involve the customer providing relevant basic data about himself and where applicable, his/her company or organization, by entering the information in designated spaces on a webpage contained within the website at the interface 110. Such information could include, for example, individual surname and/or company name, place of business - including street address, city, state, zip code, telephone number(s) and the like. Even more detailed information could include relevant financial data, such as capital assets, liabilities, tax structure and the like pertaining to the customer's business or organization.

The basic data would be electronically transmitted to the broker interface 120 via communication line 112 and could be used to establish a “profile” for the customer which would be stored in a database contained within the interface 120. An optional feature of the RFQ system and method would be the availability of the broker via the broker interface 120 (on-line) during the customer pre-registration process to consult with the customer and thereby address any questions that the customer may have about the RFQ process, etc.

As a further part of pre-registration, the customer would also preferably be required to agree to any posted terms and any legal disclaimers relating to the RFQ process as might be established by the broker via the interface 120. Upon receipt of the customer pre-registration information at the broker interface 120, the broker would then issue the customer a unique password via line 112 to the customer interface 110. Subsequent access to the system 100 necessary to initiate the RFQ process, hereinafter described, would typically be attained through use of the unique password provided to the customer. The RFQ system 100 would preferably be configured so that the RFQ process could only be initiated by a password. As those skilled in the art will recognize, the password could also be issued prior to the customer providing any relevant data about itself, its organization, or its employees.

Also prior to the start of an RFQ process, one or more carriers would indicate their desire to participate in the RFQ system and method by pre-registration at each of the respective carrier interfaces 140, 240 and n40. Pre-registration for each carrier would be done in substantially the same manner as set forth above for the customer, including supplying relevant basic data such as company name, place of business, state of incorporation, goods and services the company deals in, and the like. In a preferred embodiment of the invention, each carrier would also furnish additional information or “financial data” about itself, which could include number of years in business, capitalization/assets, and liabilities etc. In another desirable embodiment, wherein the carrier was a financial services or insurance entity and was a purveyor of a BOLI plan, one or more of the carrier's most recent ratings, e.g. A++, as established by one or more rating companies such as Moody's, A.M. Best's, etc. could be supplied as part of the pre-registration data. Both the basic data and the financial data would be electronically transmitted to the broker interface 120 via line 112. This information could be used to establish a “profile” for each carrier which would be stored in a database contained within the interface 120. As a further part of pre-registration, the carrier would also preferably be required to agree to any posted terms and any legal disclaimers relating to the RFQ process as might be established by the broker at the interface 120. The broker would then issue each carrier a unique password via lines 132a, 132b and 132n from the broker interface 120 to each of the respective carrier interfaces 140, 240 and n40. Subsequent access to the system 100 necessary to participate in the RFQ process, hereinafter described, would typically be attained through use of the unique password provided to each carrier. In a preferred embodiment of the invention, the system 100 could be further configured, e.g. via available software at the broker interface 120, so that the broker could pre-screen a potential carrier before issuing it a password. In this way, the broker could ensure that only carriers meeting certain minimal financial requirements, for example those having adequate capitalization, would be participants in the RFQ process. As with the customer, the password for the carrier could also be issued prior to the carrier providing salient information about itself.

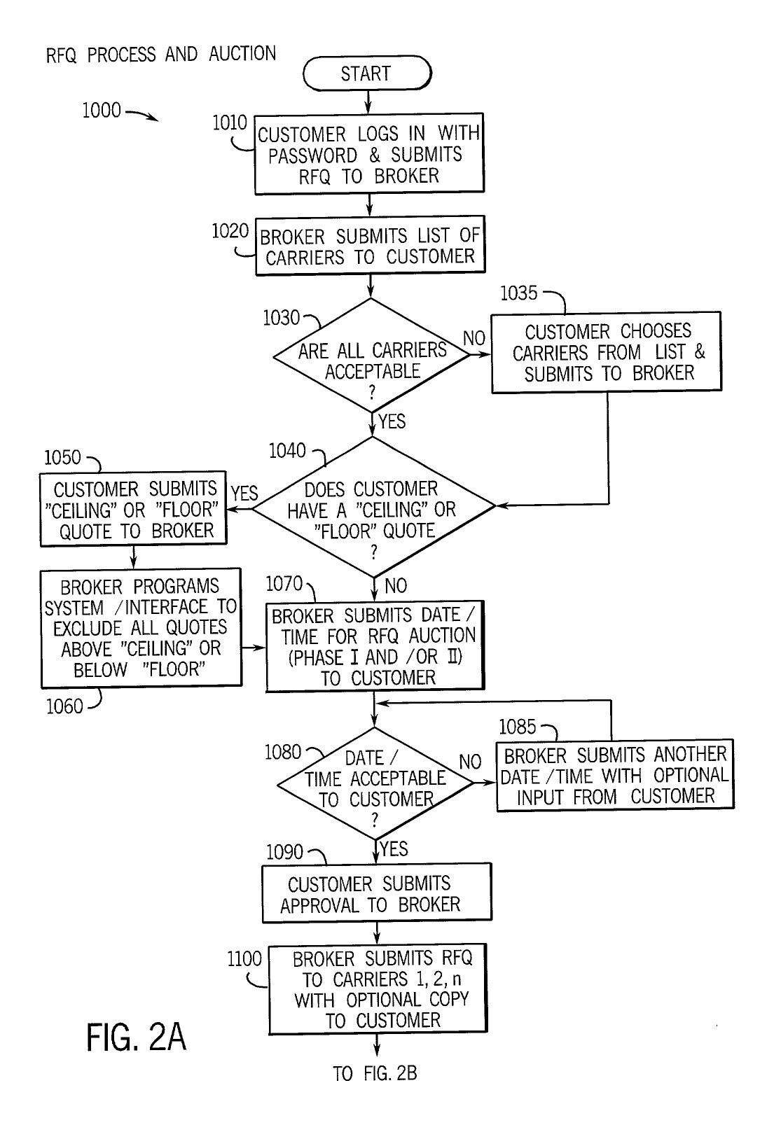

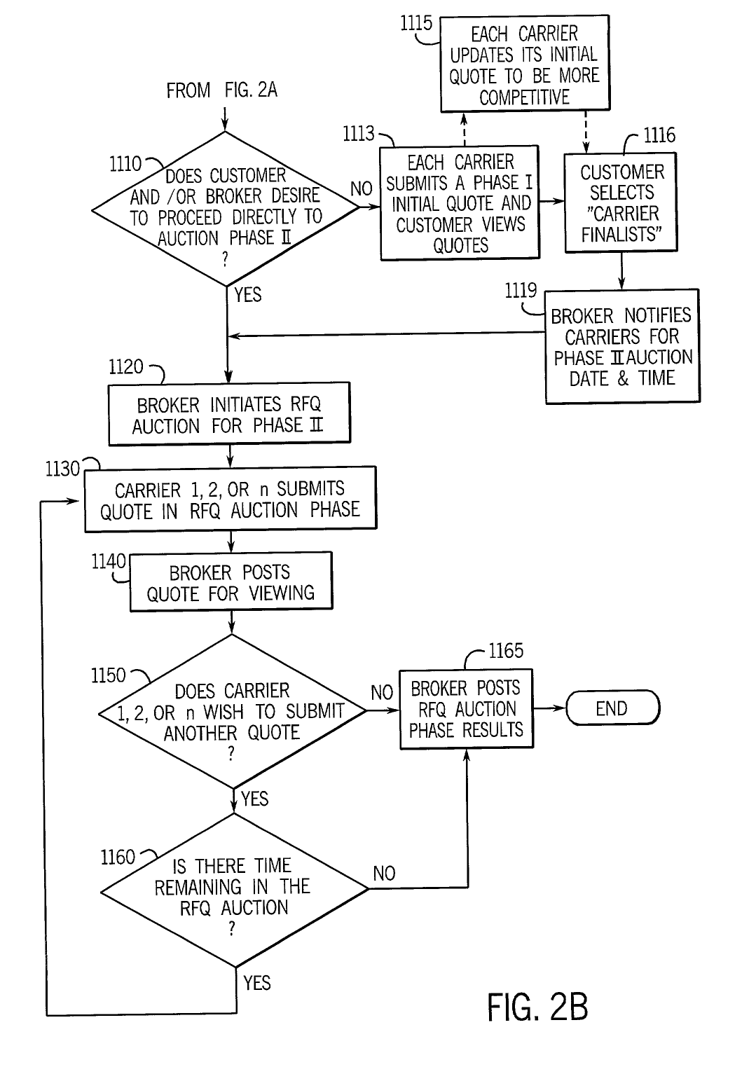

Referring now also to FIG. 2, the RFQ process is described in further detail. The customer would interface the system 100 via the customer interface 110 to initiate the RFQ process and auction 1000. After pre-registration as set forth above, the customer would log on to the designated website and enter in his password to begin the RFQ process as shown in step 1010. As part of step 1010, the customer would also enter in his request for quote or “RFQ” by indicating a product he wished to receive a price quote on, along with any optional specification(s) related to the product. The product could be selected from any number of goods and even services. Preferably, the customer's RFQ would pertain to banking and insurance services, such as a rate of return on funds deposited through a BOLI policy or other financial vehicles. Thus, the customer would be seeking the best rate of return on its deposited funds when submitting an RFQ on a BOLI plan.

Referring now also to FIG. 3, optional product specifications as part of step 1010 could include any number of descriptive parameters which the customer could use to further define the product. For tangible goods, this information could include size, color, model, geographic origin and the like. In a preferred embodiment of the invention where the customer was a bank or other financial institution interested in purchasing BOLI, then the information could include whether or not the customer had ever purchased BOLI before. The customer would also provide additional information known as “census data” at the interface 110. Census data would include actuarial information and statistics about the customer's employees, such as age, sex, marital status, number of dependents and income etc. This census information would in turn be useful for an insurance carrier in providing quotes and/or rates of return for one or more BOLI life insurance policies on the customer's employees. FIG. 3 illustrates a sample census data form to be completed by the customer. In addition, for services such as BOLI, a product specification could include a guaranteed number of years on a rate of return.

As a further component of the RFQ process in step 1010, the customer could also optionally provide some sort of “product usage” information along with the RFQ. The product usage information could include certain statistics such as the estimated quantity of the product(s) that the customer may have used within a certain time period, etc. The system 100 could also be configured so that the customer could successively request quotes for any number of additional products via the interface 110. As a final component of step 1010, the customer would then transmit its RFQ from the customer interface 110 to the broker interface 120 via line 112, which as previously set forth is preferably any electronic link, e.g. modem link.

As shown in step 1020, upon receipt of the RFQ via the broker interface 120, the broker would preferably review the customer's RFQ to ascertain that all requisite information had been supplied. This could be done, for example, with appropriate available software installed at the broker interface 120 that would ascertain that all “required fields” had been entered. Upon receipt and optional review of the RFQ, the broker would submit a list of suitable, pre-registered carriers to the customer at the interface 110 via communications link 112. As an example, if the customer submitted an RFQ for Product A, and the carriers of Product A included pre-registered companies BCD, EFG and HIJ, then the broker could so notify the customer as shown in step 1020. If all carriers were acceptable to the consumer, then he would so indicate via step 1030. Alternatively, if the customer did not wish company BCD or any other carrier, for example, to participate in the RFQ process and auction, then he would indicate as such to the broker via step 1035. As part of step 1035, the customer would thus effectively choose the carriers to participate in the RFQ process and subsequent auction. Alternatively, the customer could affirmatively select the desired carriers from a listing while initiating the RFQ process in step 1010 above.

As a further option of the RFQ process illustrated in steps 1040, 1050 and 1060, the customer could also indicate to the broker a “ceiling quote”, or a maximum price above which the customer would not want to receive a quote on the desired product. In another embodiment of the invention, the customer could indicate to the broker a “floor quote”, or a price below which the customer would not want to receive a quote on a certain product. The customer might wish to establish a floor quote when requesting a quote on rates of return for life insurance premiums paid as part of a BOLI plan, for example, of say “6.47% annually for a term of X years.” This would mean that the customer, e.g. a bank, would not accept a rate of return lower than the stated amount and thus would not be interested in any BOLI carrier whose quote was below that minimum, or floor quote. The broker interface 120 could then be programmed by the broker to automatically exclude any quotes greater than or above the ceiling quote, or any quotes less than or below the floor quote, as the case may be, from the RFQ process and auction. In this way, the broker interface 120 would essentially pre-screen all quotes, preferably using available software, to ensure that each was at or below the optional specified ceiling quote, or alternatively, was at or above the optional specified floor quote, prior to posting in the staging area 130, as hereinafter described.

As shown in step 1070, the broker via the broker interface 120 would confirm receipt of the customer's RFQ and provide a proposed time and date for the RFQ Phase I qualifying period and/or Phase II auction, hereinafter described, to the customer at its interface 110 via line 112. Preferably, only the date and time for the Phase I qualifying period would be proposed in step 1070. As shown in steps 1080 and 1090, the customer, in turn, would confirm his approval of the RFQ Phase I date and time. Alternatively, as shown in step 1085, the customer would interact with the broker to establish a mutually agreed upon date and time. As a further alternative in step 1085, the customer would simply choose the RFQ Phase I and/or Phase II auction date from a listing provided by the broker. As an example, an RFQ bidding date and time could be established as dd/mm/yy from 9:00 am to 5:00 pm EST, or as otherwise mutually agreed upon by the customer and broker through the cycle of steps 1080, 1085 and 1090.

Referring now to step 1 100 in FIG. 2, the customer's RFQ would be posted in the staging area 130 of the interface 120 by the broker, and the carriers which had been selected to participate in the RFQ process would be notified of the RFQ Phase I and/or Phase II bidding date and time established above via lines 132a, 132b and 132n, respectively. and would be able to view the actual submitted RFQ through access to the staging area 130. Notification could optionally be done anonymously so that the carriers would not know the customer's identity. Preferably, notification would be partially anonymous, with the carriers not knowing the exact identity of the customer, but still receiving “census data” about the customer or its employees. This embodiment would be especially desirable where a customer had submitted an RFQ on BOLI insurance policy prices and/or rates of return, for example. The carrier would require the “census data” or actuarial data about the employees (age, whether a smoker, etc.) in order to formulate its best quote on a rate of return on the premiums deposited through BOLI. In addition, the system could optionally be configured so that carriers which had not been selected to participate in the RFQ process could also be notified, and preferably in a different manner than those carriers which had been chosen.

At step 1110, either the customer and/or the broker would decide whether to proceed directly to the auction phase of the RFQ process as shown in step 1120 (“Phase II”), or preferably would request an optional initial quote from each of the selected carriers through the Phase I qualifying period illustrated in steps 1113, 1116 and 1119 before proceeding to the Phase II auction. As shown starting with step 1113, each of the selected carriers would transmit an initial quote in response to the RFQ on the date and during the time period which had been specified in step 1070. An optional feature of the system could include a quote matrix and/or notes field by which each carrier could qualify/describe its initial quote or include product specifications as part of step 1113. This initial quote, along with any optional conditional terms, qualifications or product specifications (quote matrix), would then be transmitted via line 132 to the broker interface 120. Each initial quote from each of the carriers could be transmitted successively or simultaneously, but in any event it is preferred that each carrier would submit its initial quote without knowing another carrier's quote. In this way, each carrier is encouraged to submit a reasonably competitive quote right from the start. Each initial quote would then be posted by the broker, preferably electronically, in the staging area 130 for viewing by the customer, and if desired, by the other chosen carriers as well. The quote could also be forwarded directly to the customer at the customer interface 110. An optional step would comprise the broker first pre-screening or reviewing the quote to ensure that it was within preestablished guidelines, e.g. as regards any specified ceiling quote or floor quote as heretofore described, before posting to the staging area 130 or forwarding it directly to the customer.

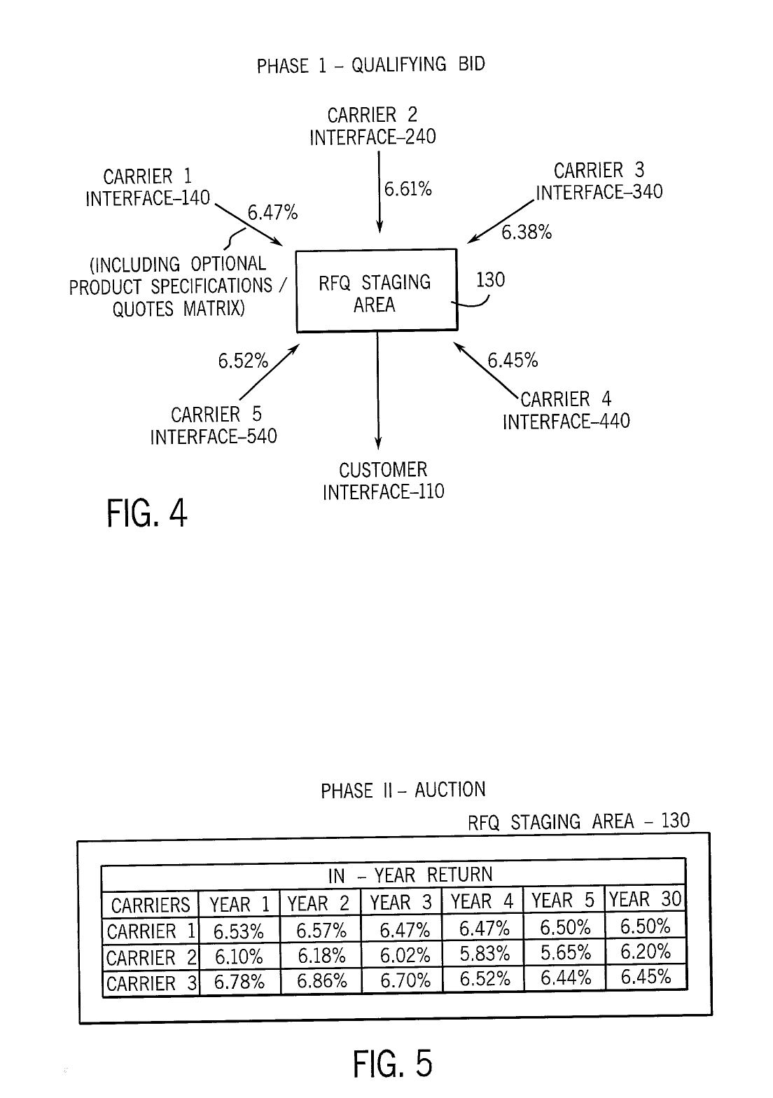

Referring now also to FIG. 4, there is illustrated a schematic representation of step 1113 for a BOLI transaction. Next to each of the carrier interfaces 140-540 is shown a sample percentage rate of return (%) which each carrier 1-5, respectively, has submitted in response to an RFQ from a customer, e.g. a bank, that was interested in purchasing BOLI. These percentages could represent, for example, annual rates of return on the funds (premiums) which the bank as customer was seeking to deposit in a BOLI plan. Each rate of return along with the carrier's name (and optional quote matrix/product terms or specifications) would be posted by the broker in the RFQ staging area 130 for viewing by the customer at the customer interface 110.

In a further optional embodiment of the invention starting with step 1113 in FIG. 2 and then proceeding to step 1115, each carrier after submitting its initial quote may be allowed to update its quote after viewing the quotes submitted by other carriers. In this way, each carrier would be permitted to provide a more competitive quote during the Phase I stage of the RFQ process before proceeding to step 1116 below. Phase I of the process thus becomes a preliminary or qualifying auction stage of the RFQ process according to this embodiment.

In step 1116, the customer would then select and transmit to the broker interface 120 via line 112 a “slate” of finalists, or carriers who had submitted the n best initial quotes in step 1113. As an example, if the customer had chosen seven carriers to submit initial quotes, and after step 1113 only felt that four of those carriers had submitted acceptable bids and should therefore compete against one another in the auction phase (“Phase II”) of step 1120, then he would so indicate in step 1116. Optional interactive technology as part of the broker interface 120 and linked to the customer interface 110 via line 112 could allow the customer, before making its final choice of carriers, to query the broker as to any qualifications or explanations which may have been provided with one or more of the initial quotes. At step 1119, the broker would notify each of the “finalist” carriers that it had been selected to participate in the auction phase (“Phase II”) of the RFQ process by posting the customer's choices in the staging area 130 for viewing via lines 132a, 132b and 132n. (Alternatively, the customer could simply select one carrier in step 1116 and go with that carrier's quote on the product, obviating the need to proceed to Phase II altogether.) If a date and time for the Phase II auction period had not already been established, then as part of step 1119 the broker with input from the customer and/or carriers would establish a Phase II auction period.

The RFQ process then would continue to the auction phase (“Phase II”) such that the broker as shown in step 1120 would initiate the auction on the bidding date and at the time which was established in steps 1070 through 1090, or as part of step 1119. Also as part of step 1120 the broker would notify the customer at the customer interface 110, and the selected carriers via the carrier interfaces 140, 240 and n40 that the Phase II auction had started. Notification would occur via the links 112 and 132 series, respectively.

At step 1130 in the process, the Phase II auction phase would preferably commence with a posting by the broker in the staging area 130 of the successful carriers and their respective quotes that had emerged from Phase I. Thereafter, the auction itself would commence when a first carrier would transmit a first or opening quote at its interface 140 in response to the posted RFQ from step 1100. If the Phase I series of steps 1113, 1116 and 1119 had previously been taken, then preferably the opening quote at step 1130 would be different, e.g. more competitive, than the initial quote submitted in step 1113 as part of Phase I

In step 1140, the quote would be received by the broker at the broker interface 120. An optional step as previously mentioned would comprise the broker pre-screening or reviewing the quote. This would again ensure that the quote was within pre-established guidelines, e.g. as regards any specified ceiling quote or floor quote as heretofore described. (Optionally, a carrier whose quote did not meet pre-established guidelines could then be electronically notified that its quote was not acceptable and/or could be further advised to then re-submit another quote.) As part of step 1140, the broker would then post the prescreened quote to the staging area 130. Preferably, this would be done electronically via the broker interface 120. The RFQ system and process is desirably configured so that this quote could then be viewed at the customer interface 110, as well as at the other carrier interfaces 240 and n40. (Alternatively, the quote could be transmitted directly to the customer interface and/or the carrier interfaces without going through the staging area 130.) After the first quote was posted, a second carrier could choose to submit a second quote as shown in step 1150, provided sufficient time remained in the RFQ auction phase as shown in step 1160. If there was no time remaining in the auction period, or if no carrier wished to submit a second quote, then the broker in step 1165 would post the auction results in the staging area 130 at the broker interface 120 for viewing by all parties via the links to the respective interfaces as heretofore described. The RFQ process and auction would then end. More preferably, however, a second carrier would submit a second quote as shown again in step 1130. This second quote could either be the same or depending upon the product, would be a “better” or more competitive quote than the first quote. This second quote could either be higher (e.g. rate of investment return), or could be lower (e.g. price for a sofa) than the first quote submitted by the first carrier. As shown again in step 1140, this second quote would also be routed from carrier interface 240 via line 132b to the broker interface 120 where it would be posted at the staging area 130 for viewing by the customer and the other carriers via the lines as set forth above. (Alternatively, the quote could be transmitted directly to the customer interface and/or the carrier interfaces without going through the staging area 130.)

In a preferred embodiment of the invention, the RFQ system could be configured so that at least one additional carrier must submit a quote in response to another quote within a specified time period in order for the auction phase to continue, or in order for the additional carrier(s) to remain in the auction. For example, if a first carrier submitted its quote at 9 a.m., then a second carrier would preferably have a fixed time period, for example, one hour, within which to submit a second quote. In this way, the RFQ process would become a live on-line auction, with each carrier bidding competitively against all other selected carriers to deliver its best or most competitive quote for a product desired by the consumer.

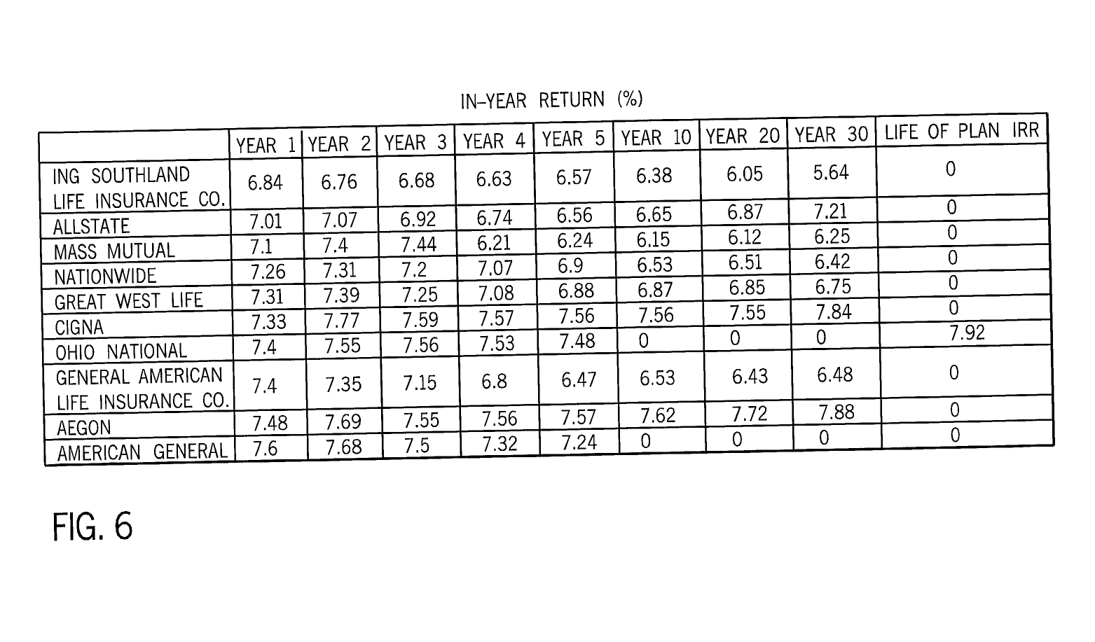

Referring now also to FIGS. 5 and 6, successive quotes would then be submitted by the same or additional participating carriers and posted by the broker using the cycle of steps 1130, 1140, 1150 and 1160. Preferably, the only limitations on the number of quotes which could be submitted during the RFQ auction phase would be the time limitation which had previously been approved in steps 1070 through 1090. Another optional feature of the system and process could be notification to either the customer or the carrier(s), or preferably both, during the auction phase of the time remaining until the end of the auction. FIGS. 5 and 6 represent real-time charts for posting each carriers' most recent quotes for BOLI rates of return for years 1-30 in the RFQ staging area 130. As can be seen from the chart in FIG. 5, carrier 3 has currently submitted the highest quotes during the Phase II auction. At a further point in time during the auction phase not shown in FIG. 5, carriers 1 and 2 could update their quotes through the cycle of steps 1130 - 1160 so as to exceed the quotes provided by carrier 3. These higher quote(s) would then be reflected in the chart shown. FIG. 6 is a more detailed view of the RFQ Phase II auction quotes in which actual BOLI carriers are shown in the left-hand column.

An optional feature of the invention would allow the customer to sort the quotes according to one or more parameters, such as for example, highest to lowest quote, by carrier, or by any other available parameter. Another optional feature would allow the customer either before, during or after the auction phase to “click” on one or more of the carriers to gather information about them. In the case of a BOLI carrier, the information could include the carrier's financial rating, how much BOLI they have sold, etc. The information would preferably be formatted for easy viewing by the customer.

As shown in step 1165, the auction phase and RFQ process would be terminated by the broker after all carriers had finished submitting their quotes, and/or the designated time for the auction had expired. As part of step 1165, there would be a posting by the broker of all the quotes submitted, which preferably would include the best or most competitive quote in the staging area 130. This “winning” quote could thus be viewed at customer interface 110 and at the respective carrier interfaces 140, 240, n40 etc. in the manner as heretofore described using the configuration and system of FIG. 1. As part of step 1165, other optional statistics could also be posted by the broker with the winning quote, preferably in summary format. These could include, for example, all quotes received, the median quote, the total number of quotes, and any optional condition terms or qualifications included with a quote by any of the participating carriers. An optional further step not shown in FIG. 2 could include notification by the customer to the “winning” carrier, indicating that the customer had selected that carrier's most competitive quote from the just-ended RFQ process auction. Most likely, the customer would select either the lowest quote or the highest quote as the most competitive quote, depending on the good or service, but could choose to select a “middle” quote, for whatever reason. In a preferred example where the customer had submitted an RFQ for a BOLI product, then the “winning” quote would most likely be the highest rate of return, e.g. “7.14%”, which a participating BOLI carrier could provide to the customer on funds which the carrier would invest for the customer. From that point, the customer would be free to fully consummate the transaction by submitting an actual purchase order for the product to the “winning” carrier. A further optional feature of the RFQ system 100 could include means for ordering the product desired once the RFQ process had been completed, as in for example an on-line order form.

In a further embodiment of the invention, the RFQ system 100 could be configured for implementation of a more traditional “reverse” auction. In this type of auction, a carrier would present its goods or services for bidding on-line by one or more consumers.

The foregoing description is illustrative of exemplary embodiments which achieve the objects, features and advantages of the present invention. It should be apparent that many changes, modifications, substitutions may be made to the described embodiments without departing from the spirit or scope of the invention. For example, while specific reference has been made to BOLI products and services, it is to be understood that the system and method of the invention is applicable to a wide range of goods and services. In addition, further reference has been made to an electronic medium, e.g. the internet, useful in practicing the system and method. However, other non-electronic mediums are also encompassed by the invention. Thus, the invention is not to be considered as limited by the foregoing description or embodiments, but is only limited by the construed scope of the appended claims.

What is claimed as new and desired to be protected by Letters Patent of the United States is:

1. A method for a consumer to obtain a price quote for a product, comprising:
submitting a request for a quote by the consumer to a staging area, wherein said quote includes at least one product specification;
forwarding said request from said staging area to at least one carrier; and
routing at least one quote from said carrier to said consumer via said staging area in response to said request.

2. The method of claim 1, wherein said staging area is controlled by a broker.

3. The method of claim 2, wherein said method is electronic and said staging area is electronically controlled by a broker.

4. The method of claim 3, further comprising pre-screening said quote in said staging area so as to be at or below a certain maximum prior to routing to said consumer.

5. The method of claim 4, wherein said request is forwarded to two or more carriers.

6. The method of claim 5, wherein each of said carriers routes a quote to said staging area so as to provide at least two quotes to said staging area.

7. The method of claim 6, wherein each of said quotes is posted in said staging area and is viewable by each of said carriers.

8. The method of claim 7, wherein at least one of said carriers revises said quote after viewing said quotes of other carriers.

9. The method of claim 8, wherein the most competitive of said price quotes is routed to said consumer.

10. The method of claim 1, further comprising providing a consumer profile to said carrier prior to or while forwarding said request for a quote to said carrier.

11. The method of claim 4, wherein said pre-screening is performed by a broker.

12. The method of claim 11, wherein after said pre-screening, said carrier is notified that its said quote is not at an acceptable level.

13. The method of claim 1, wherein said request for a quote is submitted anonymously so that said carrier does not know the identity of said consumer.

14. The method of claim 13, wherein said request is submitted along with a profile of said customer, wherein said profile contains selected actuarial facts about said customer or one or more employees of said customer.

15. The method of claim 1, wherein said quote is routed within a specified time period.

16. The method of claim 1, wherein said quote is the most competitive quote which is routed from a first carrier.

17. The method of claim 16, wherein said quote is the most competitive quote from a first carrier in competition with at least one other carrier.

18. The method of claim 17, wherein each of said carriers submits a quote in response to another quote by another of said carriers.

19. A method for at least two carriers to provide a price quote for a product in response to a request for said quote from a consumer, comprising:
submitting a first price quote from a first carrier to a staging area;
reviewing said price quote; and
submitting a second price quote from a second carrier to said staging area.

20. The method of claim 19, wherein said method is electronic.

21. The method of claim 20, wherein said staging area is electronically controlled by a broker.

22. The method of claim 21, wherein said request for said quote is submitted by said consumer to said staging area.

23. The method of claim 21, wherein more than two carriers submit a price quote such that said carriers are in competition with one another, and further wherein said method is an auction.

24. The method of claim 23, wherein said first carrier submits a first price quote and said second carrier submits a second price quote after reviewing said first price quote.

25. The method of claim 24, wherein the most competitive of said price quotes is transmitted to said consumer.

26. The method of claim 21, wherein said broker reviews said price quote.

27. The method of claim 26, wherein said step of reviewing said price quote comprises assessing whether said price quote is at or below a pre-determined maximum.

28. The method of claim 27, wherein said step of reviewing further comprises rejecting a price quote which is above said pre-determined maximum.

29. The method of claim 21, further comprising pre-registering said carrier with said broker prior to submitting said first price quote.

30. The method of claim 29, wherein after said pre-registration said carrier is notified and selected to participate in said method by said broker.

31. The method of claim 30, further comprising establishing certain date and time parameters for said method.

32. The method of claim 31, wherein said method is conducted within a specified time period.

33. The method of claim 32, further comprising notifying said carrier of a starting time and an ending time corresponding to said specified time period.

34. The method of claim 33, further comprising notifying said carrier of the time remaining within said specified time period.

35. The method of claim 34, wherein said carrier does not know the identity of said consumer.

36. The method of claim 35, further comprising notifying said carrier that its quote is being transmitted to said consumer.

37. The method of claim 19, wherein said price quote includes a qualification.

38. The method of claim 37, wherein said qualification includes conditional terms pertaining to said product.

39. A method of brokering a transaction, comprising:
receiving at least one request for a price quote from a consumer for a product the consumer is interested in purchasing;
receiving at least one price quote from a first carrier of said product;
receiving a second quote from a second carrier of said product; and
posting said request and said price quotes to a staging area.

40. The method of claim 39, wherein said method is electronic and said transaction is an on-line auction.

41. The method of claim 40, wherein said staging area is an electronic viewing area.

42. A system for conducting an on-line auction, comprising:
an electronic staging area linked to a broker interface, wherein said staging area displays requests for price quotes on products submitted by consumers, and also displays responses to said requests by one or more carriers of said products.

43. The system of claim 42, further comprising a customer interface and a communications link between said customer interface and said broker interface.

44. The system of claim 42, further comprising a carrier interface and a communications link between said carrier interface and said broker interface.

45. The system of claim 42, wherein said staging area is controlled by a broker through said broker interface.

46. The system of claim 42, wherein said broker interface includes a database.

47. The system of claim 46, wherein said broker interface comprises means for conducting an on-line auction.

48. The system of claim 47, wherein said means further comprises means for posting price quotes in said staging area received during said on-line auction.

49. The system of claim 48, wherein said staging area further displays a price quote matrix.

50. The system of claim 44, wherein said system comprises at least two carrier interfaces.

51. The system of claim 44, wherein said system comprises at least two customer interfaces.

52. A method for a broker to conduct an on-line auction, comprising:
pre-registering at least one customer who is interested in obtaining a competitive price quote on a product;
pre-registering at least two carriers of said product;
establishing a time for said auction;
having said at least one customer submit a request for a price quote during said auction time;
having a first carrier submit a first price quote in response to said request;
posting said first price quote for viewing by at least one of said customer and said carriers;
having a second carrier submit a second price quote in response to said request and to said first price quote; and
posting said second price quote for viewing by at least one of said customer and said carriers.

53. A method for competitively quoting a rate of return for premiums deposited in a bank-owned life insurance (BOLI) policy, comprising:
pre-registering at least one financial institution that is seeking to make a purchase of BOLI and that desires to receive a competitive quote on the rate of return from said deposit in BOLI;
pre-registering at least two carriers of BOLI;
establishing an auction time and period;
having said financial institution submit a request for a quote during said auction;
having a first carrier submit a first rate-of-return quote in response to said request;
posting said quote;
having a second carrier submit a second rate-of-return quote in response to said request and to said response from said first carrier; and
posting said second quote.

54. An electronic system useful in conducting an on-line auction for rates-of-return on funds deposited in bank-owned life insurance (BOLI), comprising:
a broker-controlled staging area for displaying requests by financial institutions for rates of return on said BOLI funds, and for displaying responses received to said requests during an on-line auction, wherein said staging area is in communication with a broker interface.
